(19) United States
(12) Patent Application Publication
(10) Pub. No.: US 2020/0082400 A1
(43) Pub. Date: Mar. 12, 2020

(54) Electronic Wallet Enterprise System Comprising Guaranteed Electronic Payment Transactions

(71) Applicant: James Eugene Paullus, JR., Holly Lake Ranch, TX (US)

(72) Inventor: James Eugene Paullus, JR., Holly Lake Ranch, TX (US)

(21) Appl. No.: 16/126,915

(22) Filed: Sep. 10, 2018

(51) Int. Cl. G06Q 20/40; G06Q 20/36

(52) U.S. Cl. CPC G06Q 20/403; G06Q 20/36

(57) ABSTRACT

The Electronic Wallet Enterprise System provides a Single Point Access system comprising a payment system, a commerce system, a data system, a reports system, a management system, a security system, a hub routing system and a proprietary automated program code whereas the system provides an interface convergence of all systems for users to have Single Point Access to all system functions using a wireless mobile phone device, a wireless tablet device or a computer device. The Payment System comprises a central electronic wallet payment arbiter, a payer node, a payer electronic wallet, a payee node, a payee electronic wallet whereas the central electronic wallet payment arbiter arranges a guaranteed electronic payment transaction from the payer electric wallet to the payee electronic wallet. Stable intrinsic transaction value is maintained with equal U.S. dollar value of U.S. FDIC insured dollars or gold bullion backing on deposit.

### CROSS REFERENCE TO RELATED APPLICATIONS

This application claims the benefit of U.S. Provisional Patent Application Ser. No. 62/559,358, filed Sep. 15, 2017, the disclosure of which is hereby incorporated by reference.

### BACKGROUND

Technology advancements in mobile and wireless devices provide people the opportunity to live a very active mobile lifestyle both domestically and globally. The use of mobile devices to complete electronic payment transactions is a growing trend. Yet, current electronic payment transaction systems require use of a “pull money” method that exchanges sensitive accountholder information and produce major security breaches with huge fraud losses. In 2014 fraud loss was $16 billion, and in 2015 fraud loss was $22.1 billion. Electronic payment fraud loss is forecast into the foreseeable future as it continues going higher each year. Referenced fraud loss information is based on Nilson reports. People living today's mobile lifestyle also have problems with information management activities.

Information required for management is held in “Closed Information Systems” that has login restricted access. Access to the information plus the ability to interface, converge, consolidate and integrate into an end user's management system are difficult and time consuming. Consumers, business, transportation, industry, education and government entities experience the negative effects of fraud loss and information fragmentation.

The solution is an Electronic Wallet Enterprise System comprising an electronic wallet method that includes real time guaranteed electronic payment transactions and a automated information exchange method for gathering a convergence of information and integrating the gathered information for distribution to the related user for use in management activities using a mobile device, wireless device or a computer device.

### BRIEF DESCRIPTION OF THE DRAWINGS

For a more complete understanding of the present invention, reference is now made to the following descriptions taken in conjunction with the accompanying drawings, in which:

FIG. 1 illustrates an embodiment of the electronic wallet enterprise system group that enables task interaction among groups and group modules.

FIG. 2 illustrates an embodiment of the payment group and subgroup modules used for payment funding, funding verification and payment transactions.

FIG. 3 illustrates an embodiment of the commerce group and subgroup modules used for commerce activities

FIG. 4 illustrates an embodiment of the data group and subgroup modules used for data storage, research, networking, financial ledger, marketing and distribution activities

FIG. 5 illustrates an embodiment of the reports group and subgroup modules used for providing reports

FIG. 6 illustrates an embodiment of the management group and subgroup modules used for gathering and providing management information.

FIG. 7 illustrates an embodiment of the security group and subgroup modules used for security identification verification and security access control

FIG. 8 illustrates an embodiment of the hub routing group and subgroup modules used for user access routing and group security controls

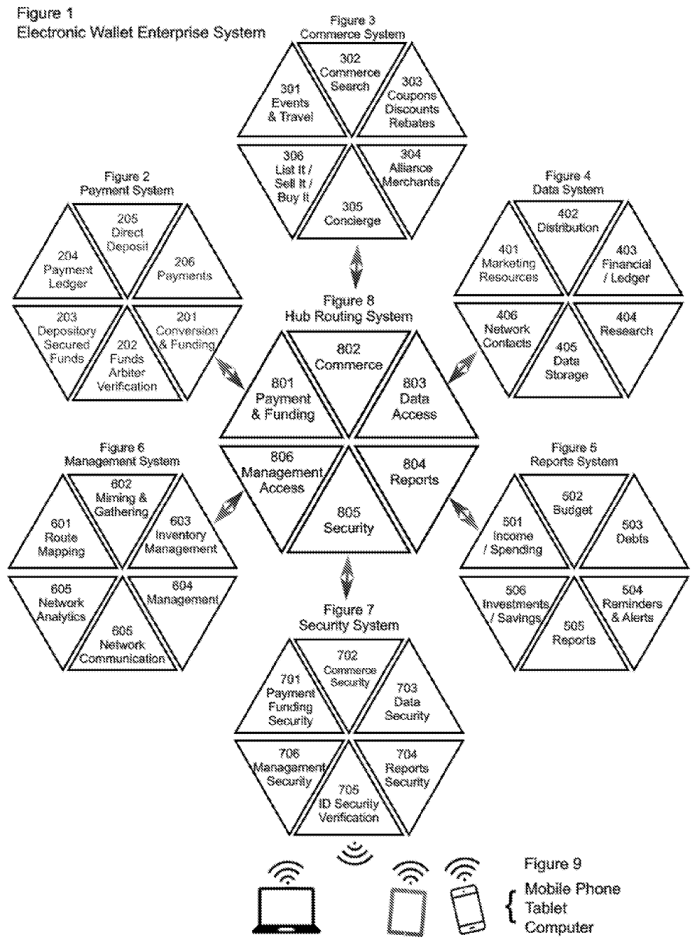

### DETAILED DESCRIPTION

To better understand the advantages of the invention, current methods used for electronic payment transactions and management information access will be discussed first.

Electronic payment methods used currently rely on a “pull money” system. The pull money system requires the payer to provide payer's private account information to the payee so the payee can pull funds from the payer's account. This information exchange relies on a complex third party routing, clearing and verification process to complete a transaction. Efforts to restrict criminal access to payer's private account information continue to fail. The exchange of private account information results is an extremely high risk of information mis-use, identity theft and fraud losses will occur. Electronic payment methods used currently do not provide the added functionality of an Electronic Wallet Enterprise System comprising an electronic wallet method that includes real time guaranteed electronic payment transactions and the functionality of access to added automated services using a mobile device, wireless device or a computer device.

The Electronic Wallet Enterprise System is a system comprising: a central electronic wallet payment arbiter 202, a payer node, a payer electronic wallet, a payee node, a payee electronic wallet whereas the central electronic wallet payment arbiter arranges a guaranteed electronic payment transaction 205 from the payer electronic wallet to the payee electronic wallet.

A new user starts at the Electronic Wallet Enterprise System website by downloading the system application onto their device FIG. 9. The new user completes set-up registration and identity security verification 705. Next the new user completes account funding of the new electronic wallet account 201, 202, 203 & 204. Inbound account funding use pre authorization and verification methods 201 & 202 to assure the inbound funds are, “Good Funds.”

For users opting to back their electronic wallet with FDIC insured U.S. dollars; all inbound U.S. dollar funds are placed on deposit in an FDIC insured bank facility 203. For users opting to back their electronic wallet with gold bullion, the inbound U.S. dollars are used to buy gold at the daily market rate. The gold bullion is secured in a level 4 depository facility 204. The account funding process is the same for foreign users with exception all acceptable foreign currency is first verified to be good funds and then exchanged and converted into U.S. dollars 201 & 202 and then continuing with the same depository process. Upon completion of funding the electronic wallet, the new user is issued units of a proprietary cryptocurrency with a value 204 of; one cryptocurrency unit equals one U.S. dollar. This cryptocurrency unit value applies to all Electronic Wallet Enterprise System users.

The new user can now send guaranteed electronic payment transactions 206 since the intermediary arbiter verification relationship 202 of the Electronic Wallet Enterprise System allows the system to verify the payer account balance 204 before sending the guaranteed payment transaction 206. The system is also able to post the transaction to the payer's account ledger and the payee's account ledger 204 in real time. The transactions are recorded on the ledgers as proprietary cryptocurrency debits and credits since the transactions are 100% backed by U.S. dollars or gold bullion held on deposit.

An electronic wallet user may make a, “Cash Out Request.” The cash out request works the same as the inbound funding process, except in reverse. An electronic wallet user may also fund their electronic wallet account at Electronic Wallet Enterprise System alliance banks, retailers, approved merchant locations.

The inbound funding still works the same except the user funds must be ACH transferred from the alliance bank, retailer bank or approved merchant bank and processed into the user's Electronic Wallet Enterprise System depository account. The use of guaranteed electronic payment transactions eliminates sensitive accountholder information exchange between payer and payee since the Electronic Wallet Enterprise System does not use the pull money clearing systems to complete payment transactions for the exchange goods and services.

Instead, The Electronic Wallet Enterprise System relies on the system's intermediary arbiter verification 202 relationship to verify payer and payee identity 705 plus verify payer and payee account balances 204 before processing guaranteed electronic payment transactions 206.

In addition, the Electronic Wallet Enterprise System provides Direct Deposit Payroll Accounts and Biller Accounts 205. Employers are able to register and open direct a deposit payroll account. Once established, the employer can deposit guaranteed employee payroll payments 206 into the direct deposit payroll account for distribution and deposit to individual employee electronic wallet account. Biller's are able to register and open a direct deposit biller account 205. The biller is able to issue electronic bills, statements and invoices. Payment balances due the biller can be direct deposited 205 as guaranteed electronic payment transactions 206 by Electronic Wallet Enterprise System users. Forty eight percent of U.S. businesses still endue the high cost of issuing and delivering employee paper payroll checks with an average cost of $2.60 per check. Biller cost is even higher. A 2016 study revealed 16.7 billion bills were sent out with 97% prepared and mailed as paper Bills. This huge volume of paper checks and bills is costing billions of dollars plus natural resources each year. Direct Deposit Guaranteed Electronic Payment Transactions helps solve this problem. The Electronic Wallet Enterprise System includes a currency exchange and conversion system 201 & 202 that verifies, exchanges and converts any acceptable currency based on market exchange rates.

The Electronic Wallet Enterprise System is also comprising proprietary automated computer code designed to control user access to added system features and manage user task. For a better understanding, the added system features and user task are discussed here. Retailers, Manufacturers, and Warehouse Operators have access and use of management system functions 603 & 604. These management system functions are available to businesses, manufactures retailers, service providers, institutions, government, or other entity users.

The management system functions 603 & 604 provide ability to effectively plan, locate, compare, schedule, manage workforce, manage materials, maintain inventory, manage purchase orders, procure, buy, sale, pay, deploy, ship and deliver products, goods or services to anyone, anywhere. The Electronic Wallet Enterprise System maintains and provides access to a complete retail inventory management system, a manufacturing management system and warehouse management system.

The Commerce Group provides Electronic Wallet Enterprise System users ability to list, sell and buy any products or services found in the search 302 & 305 results including events and travel 301. The coupons, discounts, rebates and gift card module 303 acquire, manages and applies coupons, discounts, rebates and gift card savings when a purchase is made to maximize user cost savings. The Concierge Search 305 finds exactly what is wanted when and where it is wanted without having to deal with all the unwanted online search results. The Concierge search feature uses proprietary search tool scans and data mining to locate and harvest the end user's specified product, service or event. Discount, Coupon, Rebate and Gift Card management 303 is used to search for product and services discounts, coupons and Rebates. Users can search for a price match for a specified product or service. The search will provide results that match or beat the price match amount. The search results can be saved and sorted by product, service, brand, location, saving amount and expiration date. The automated system applies any saved Discount, Coupon, Rebate and Gift Card to all purchase transactions before payment is completed. This maximizes user savings on all purchases.

Route Map Planning 601 with the ability to enter multiple location address for a route trip. The Route Mapping proprietary program code will organize and create the most effective trip route for the trip.

Advanced Analytics and Research 404 & 605 provides ability to use available information for planning projects, budgets, and effective marketing campaigns.

Identification Verification 705 provides identity verification of new users and user access verification. The security verification module creates a random security pass code for the user's device. The security pass code provides user access to the Electronic Wallet Enterprise System functions based on consumer or business or merchant type. Security Identification uses ASE encryption two-way verification pass code communication to allow user access to each Group.

The Hub Routing Group 800 controls Security access to all Groups within the Electronic Wallet Enterprise System. During two way communication with the Electronic Wallet Enterprise System, the user's random security pass code is being replaced with a new random security pass code at random time intervals. The id security verification module 705 will recognize the last random security pass code confirmed by the user's mobile device, wireless device or computer device. The ID Security Verification Module can store and maintain the user's public ID credentials for display on the user's mobile device 900. Personal identification including driver's license, health insurance ID, employee ID, student ID or other such ID information can be stored on the user's device. Protection of personal identity information will be provided by a requirement for the personal mobile device to be protected with a personal user access code.

Users are provided Single Point Access to all user related accounts. All user related information can be gathered 602, interfaced, and integrated into a standardized format for user access and use. The user information can be used to create reports, reminders and alerts 500.

Single Point Access is able to interface with any individual, merchant, business, service provider, institution, government, bank, or other entity that provides internet connection and the user maintains an account relationship with. Single Point Access eliminates the problems related to information fragmentation.

The tutorials and leaning center 402 & 405 provide information such as tutorials, articles, training videos and other educational information that may be used to educate and inform end users on a wide range of subjects such as personal financial issues, home repairs, auto repairs, do it yourself projects, garden, photography, arts and crafts, etc.

What is claimed is:

1. (canceled)

2. (canceled)

3. (canceled)

4. (canceled)

5. (canceled)

6. A computer implemented system of guaranteed electronic payment, the system executable by a processor, the system comprising:
a central electronic wallet payment arbiter;
a payer node;
a payer electronic wallet;
a payee node; and
a payee electronic wallet, wherein the central electronic wallet payment arbiter arranges a guaranteed electronic payment from the payer electronic wallet to the payee electronic wallet.

7. The system of claim 6
wherein the payer electronic wallet and the payee electronic wallet each maintains a funds balance of FDIC insured U.S. dollars or gold bullion in a secure level 4 depository;
wherein the payer electronic wallet authorizes payment to a payee electronic wallet; and
wherein the central electronic wallet payment arbiter determines whether the payer electronic wallet prepayment funds balance exceeds the authorized payment amount;
wherein, responsive to the payer electronic wallet funds balance exceeding the authorized payment amount, the central electronic wallet payment arbiter transfers funds balance credits that equal the authorized payment amount from the payer electronic wallet ledger to the payee electronic wallet ledger;
wherein, responsive to the payer electronic wallet funds balance being below the authorized payment amount, the central electronic wallet payment arbiter sends an insufficient funds notification to the payer electronic wallet;
wherein the insufficient funds notification provides the payer electronic wallet options to cancel the authorized payment or to transfer added funds into the payer electronic wallet account that are sufficient to complete the authorized payment to the payee electronic wallet;
wherein the successful transfer of funds balance credits from the payer electronic wallet to the payee electronic wallet post funds debit to the payer electronic wallet ledger balance and a funds credit to the payee electronic wallet ledger balance;
wherein the successful transfer of funds notification is sent to the payer electronic wallet and the payee electronic wallet; and
wherein the guaranteed payment is provided as result of the central electronic wallet payment arbiter prepayment verification actions.

8. One or more computer storage devices having computer-executable instructions stored thereon for information integration and consolidation into an electronic wallet enterprise single point access method, which, on execution by a computer, cause the computer to perform operations comprising:
accessing information;
mining the accessed information to produce mined information;
filtering the mined information to produce filtered information;
storing the filtered information;
integrating the stored information using automated program coding to produce a convergence of integrated information into a plurality of electronic wallet enterprise single point access outputs, the plurality of outputs including at least one selected from the list consisting of:
reports, notifications, reminders and alerts;
security identity verification for user access using behavior identity combined with two-way code verification and or mobile phone number verification;
custom information searches;
products and services procurement;
inventory management;
custom maps and shared network information.
